(19) United States
(12) Patent Application Publication
(10) Pub. No.: US 2015/0296375 A1
(43) Pub. Date: Oct. 15, 2015

(54) Methods, devices, and computer program products improving the public warning system for mobile communication

(71) Applicant: NOKIA SOLUTIONS AND NETWORKS OY, Espoo (FI)

(72) Inventor: Guenther Horn, Munich (DE)

(21) Appl. No.: 14/439,482

(22) PCT Filed: Oct. 29, 2012
(86) PCT No.: PCT/EP2012/071404

§ 371 Date: Apr. 29, 2015

(51) Int. Cl. H04W 12/04; H04W 4/12; H04W 4/22

(52) U.S. Cl. CPC H04W 12/04; H04W 4/22; H04W 4/12

(57) ABSTRACT

The present invention relates to devices, methods and computer program products in relation to mobile communication. In particular, it relates to those devices, methods and computer program products of communication networks in relation to e.g. so-called Public Warning Systems (PWS). In order to provide improvement, an apparatus comprises: a control module configured to receive a specified message including an indication of a public key for verification of broadcast messages, in response to having received the indication, select a timer period associated with the indication of the public key received, launch a timer for the selected timer period, and, upon expiry of the timer, cause to indicate acceptance of the public key.

### FIELD OF THE INVENTION

The present invention relates to devices, methods and computer program products in relation to mobile communication. In particular, it relates to those devices, methods and computer program products of communication networks in relation to e.g. so-called Public Warning Systems (PWS).

### BACKGROUND

Public Warning Systems represent an additional service of mobile communication related to dangerous occurrence of e.g. Earthquakes, Tsunamis and the like. An example of a PWS is, for instance, the Earthquake and Tsunami Warning System (ETWS). A Public Warning System uses mobile phones to warn users of e.g. imminent disasters like earthquakes, tsunamis, hurricanes or the like. A PWS is, for instance, specified by 3GPP™ since Release 8 for all 3GPP technologies, i.e. Global System for Mobile Communications (GSM) including General Packet Radio Service (GPRS), Universal Mobile Telecommunications System (UMTS), and Evolved Packet System (EPS) also known as Long Term Evolution (LTE).

According thereto, the PWS is adapted to broadcast important information such as e.g. warning notifications, warning messages, or the like to multiple user equipments (UE), preferably simultaneously, especially, without the necessity of acknowledgment messages. The warning notifications are broadcast to user equipments UE within a certain area defined by e.g. geographical and/or network topographical information specified by a provider of the warning notification. User equipments which are capable of handling PWS may receive warning notifications broadcast. Especially, the warning notifications relate to emergencies where life or property may be affected and a responsive action is preferred to be executed.

Hence, it is an object of the invention to improve such systems.

### SUMMARY

According to a first (e.g. terminal apparatus related) aspect of the invention, there is provided an apparatus, comprising: a control module configured to receive a specified message including an indication of a public key for verification of broadcast messages, in response to having received the indication, select a timer period associated with the indication of the public key received, launch a timer for the selected timer period, and upon expiry of the timer, cause to indicate acceptance of the public key.

According to a second (e.g. network apparatus related) aspect of the invention, there is provided an apparatus, comprising: a memory module containing a public key; and a control module configured to cause to allocate the public key to an indication and a secret information determined to be contained in a broadcast message which is to be transmitted, upon request, transmit the indication, and, upon receipt of a public key acceptance information, cause to transmit the public key.

According to a third (e.g. terminal method-related) aspect, a method provided, comprising: receiving a specified message including an indication of a public key for verification of broadcast messages, in response to having received the indication, selecting a timer period associated with the indication of the public key received, launching a timer for the selected timer period, and upon expiry of the timer, causing to indicate acceptance of the public key.

According to a fourth (e.g. network method-related) aspect, a method provided, comprising: selecting a public key from a memory module, causing to allocate the public key to an indication determined to be contained in a message which is to be transmitted, upon request, transmitting the indication, and, upon receipt of a public key acceptance information, causing to transmit the public key.

According to a fifth aspect of the present invention, there are provided one or more computer program product(s) comprising computer-executable components which, when the program is run on a computer, are configured to carry out the respective method(s) as referred herein above.

The above computer program product may further comprise computer-executable components which, when the program is run on a computer, perform the method aspects mentioned above in connection with the method aspects.

The above computer program product/products may be embodied as a computer-readable storage medium.

Various further aspects of at least some exemplary embodiments of the aspects of the invention are set out in the respective dependent claims.

### BRIEF DESCRIPTION OF THE DRAWINGS

The teachings of the present invention can be readily understood and at least some additional specific details will appear by considering the following detailed description of at least some exemplary embodiments in conjunction with the accompanying drawings, in which:

FIG. 1 schematically shows a user equipment provided with an apparatus according to the invention;

FIG. 2 schematically depicts a network component configured to operate in relation to at least an exemplary aspect of the invention;

FIG. 3 schematically depicts a flow chart of a processing by a user equipment in relation to at least an exemplary aspect of the invention; and

FIG. 4 schematically shows a signaling chart related to a public key update in a user equipment according to an exemplary embodiment of the invention.

### DETAILED DESCRIPTION OF THE EMBODIMENTS

Without limiting the scope of the invention to the embodiments, the invention is illustrated in more detail by the following description referring to the accompanying drawings.

References to certain standards, media and/or resources in this description are rather supposed to be exemplary for the purpose of illustration of the invention in order to improve the ease of understanding of the invention. They are not to be understood as limiting the inventive concept. Likewise, the language as well as terms used herein such as e.g. signal names, device names and the like are to demonstrate the embodiments only. Use of such language or terms apart from their understanding according to this disclosure shall not be applied to the invention for the purpose of limiting its scope.

Generally, user equipments (UE) may be mobile devices such as cellular phones, smart phones, laptop's, handhelds, tablets, vehicles, or the like. A mobile device may also be a module which can be connected to or inserted in a user equipment.

Although wireless communication is usually established via radio as a medium, it may also be applied to ultrasonic, infrared light or the like as medium for the purpose of transmission. The transmission may be unidirectional such as broadcasting or it may be bidirectional that is in both directions. Moreover, the transmission may be provided by a communication link such as an uplink (UL) or downlink (DL).

Herein below, however, exemplary aspects of the invention will be described with reference to radio communication as wireless communication medium, especially, referring to mobile communication such as provided by GSM, UMTS, LTE, or the like.

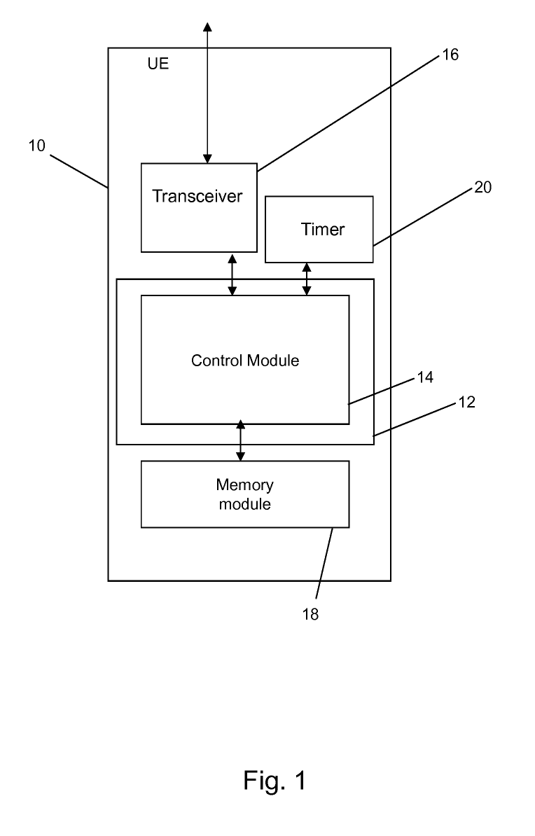

FIG. 1 depicts in an exemplary embodiment a user equipment (UE) 10 having an apparatus 12 which, in turn, comprises a control module 14. The user equipment 10 further comprises a memory module 18, a timer 20 and a transceiver 16. The memory module 18, the timer 20 and the transceiver 16 are each in communication with the apparatus 12, especially with the control module 14.

According to an exemplary embodiment, the apparatus 12 comprises: a control module 14 configured to receive a specified message such as a LAU accept, a RAU accept, or the like, including an indication of a public key PK for verification of broadcast messages, in response to having received the indication, select a timer period associated with the indication of the public key PK received, launch the timer 20 for the selected timer period, and, upon expiry of the timer 20, cause to indicate acceptance of the public key PK.

The control module 14 may be integral with the apparatus 12 or it may be established by a hardware circuitry, a computer running a program or the like. The specified message can be a message as usual in mobile communication such as an attach accept message, a Location Area Update (LAU) or Routing Area Update (RAU) accept message, other accept messages, or the like which may be provided via a preferably individualized communication link to e.g. a network entity. The apparatus 12 may be a hardware circuitry, a computer running a program, combinations thereof, or the like. So, the apparatus 12 may also be provided by a chip such as a semiconductor chip which may form a component of a user equipment (UE) 10 such as a mobile phone, a sensor equipment or the like, or it may be integral therewith.

According to an exemplary embodiment, the indication includes the public key and/or a reference allocated to the public key. The public key can be any suitable kind of key such as a certain code which can be provided by electric, optical, acoustical, or the like signals. The public key can be allocated to an indication which may be provided by a preferably individual code. Also, the indication can include the allocated public key. The public key is allocated to a secret information available in a network entity which may be used to sign a broadcast message. The broadcast message is a message which is indented to be received by a plurality of apparatuses 12, preferably at substantially the same time.

In an exemplary embodiment, there is provided a receipt of such broadcast message without acknowledge. The broadcast message can be a warning message, notification message, other important public information containing message, or the like. Preferably, the broadcast message is not directed to a specific receiver 16 but a plurality of receivers or apparatuses, respectively.

According to a further exemplary embodiment, the broadcast message is to be verified. Preferably, verification is established at reception site, e.g. by the user equipment 10, the apparatus 12, or the like. In an exemplary embodiment, verification is enabled by using the public key PK. Verification may be provided by applying the public key PK to a signature information contained in the broadcast message. The signature information may be provided in the broadcast message by a sender (other apparatus) of this broadcast message, preferably, during generation of this broadcast message.

An exemplary embodiment deals with handling of a received public key by the apparatus 12. First, the received public key is not accepted but a timer period is selected associated with the public key received. The timer period may be a time value, numerical data, preferably, as electronic signals, certain coding, or the like. Especially, the timer period is selected independently from any other entity or apparatus by the present apparatus only. One exemplary embodiment uses a timer period limit by maximum and/or minimum values.

An exemplary embodiment associates the timer period with the indication received, wherein a timer 20 is launched with the timer period. In turn, the timer 20 may be also associated with the public key. The timer 20 may be any component responding with a time period upon its operation.

One exemplary embodiment determines expiring of the timer 20, and in response to having determined expiry of the timer 20, cause to accept the public key PK. Expiry of the timer can be established by comparing a timer value with a preset reference value or the like. Preferably, a timer signal is generated indicating expiry of the timer 20. The signal may be used to accept the public key PK. Accepting may include receiving and storing the public key PK, preferably, in a certain respective storage area of the memory module 18. An accepted public key may be used for verification of broadcast messages received. Reception of a public key may also include changing a public key, e.g. which may already be provided in the apparatus 12, the control module 14, or a respective storage module 18 communicatively linked to the apparatus 12 and/or control module 14.

In an exemplary embodiment, the apparatuses 12 may select different timer periods, preferably, individual for each apparatus 12 or a group of apparatuses 12. Selecting may be established by selecting a timer period from a plurality of certain predefined different timer periods. So, the indication received by different apparatuses 12 may be accepted at different times by the different apparatuses 12.

A further exemplary embodiment uses reception parameters of a receiver 16 having received the specified message related to the public key. e.g., generating or selecting of the timer period may include considering individual field strength during reception, amendment thereof, quality parameters, and/or the like.

Another exemplary embodiment is that the control module 14 is configured to identify the indication of the public key PK received as matching a public key already stored, and, responsive thereto, stop the timer 20. Moreover, the control module 14 may be configured to identify the public key received as already stored, and stop the timer 20. Since the public key is already known to the apparatus 12, an additional operation can be avoided. The present public key can be used for verification purposes.

Furthermore, an exemplary embodiment is, when the control module 14 is configured to receive a specified message including another indication of a public key during operation of the timer 20, select another timer period associated with the other indication received, and reset and launch the timer 20 with the other timer period. Also the control module 14 can be configured to receive a specified message including another public key during operation of the timer 20, select another timer period associated with the other public key received, and reset and launch the timer 20 with the other timer period. This allows updating the public key handling and acceptance procedure. Associating the other timer period to the other public key provides for a new association of the timer 20, wherein resetting the timer 20 may allow establishing a new and independent acceptance process. The specified message can be any message related to normal operation of the apparatus such as e.g. LAU, RAU, TAU accepts or the like.

According to a further exemplary embodiment, the control module 14 is configured to select the timer period randomly. The apparatus 12 may generate a timer period independent from the other apparatus, e.g. a network entity or the like, so that preferably each apparatus 12, or at least each group of apparatuses 12, has its own individual timer period. So, it can be achieved that the public key is accepted by the apparatuses 12 at preferably individual differing times.

According to another exemplary embodiment, the control module is configured to cause to transmit a request for a public key.

Another exemplary embodiment requires the control module 14 being configured to cause to transmit a message related to the timer 20 expiry. The message can be included in specified messages such as e.g. LAU, RAU, TAU requests, or the like. Preferably, the message may contain information about the timer 20 being running, stopped, reset, or the like.

According to another exemplary embodiment, the control module 14 is configured to cause to transmit a request for a public key. The request can be transmitted as part of an attach request, a LAU or RAU request, combinations thereof, or the like. Preferably, the request is transmitted to the other apparatus, especially, the network entity. Preferably, the request is transmitted when the present public key is invalid, during cell handover, when the apparatus 12 or the user equipment 10, respectively, is initially attached, or the like.

Yet another exemplary embodiment is that the control module 14 is configured to cause to transmit a message related to the timer expiring. So, the message may contain information about the timer status, e.g. whether the timer 20 is still operating, the estimated duration of timer 20, timer expiring, and/or the like. This information enables the other apparatus or network entity, respectively, to suppress further public key transmissions. So, a chain of to be aborted acceptance procedures in the apparatus 12 can be avoided. Moreover, transmission expense by the other apparatus or network entity, respectively, can be reduced.

According to a further exemplary embodiment, the apparatus 12 comprises further a transceiver 16 and the timer 20. So, the apparatus 12 may establish a user equipment 10 such as mobile phone, or the like.

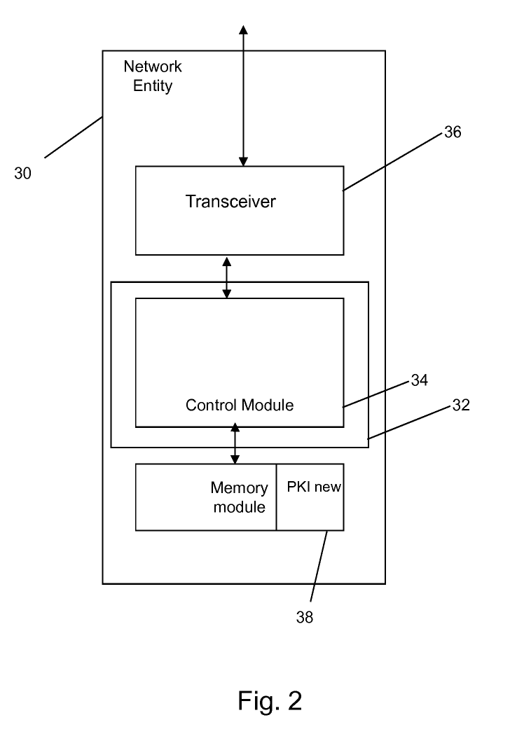

FIG. 2 depicts a network entity 30, comprising an apparatus 32 a control module 34 being in communication with a transceiver 36 and a memory module 38. The control module 34 may have a detector in order to detect receipt of request messages of other apparatuses 12 such as shown in FIG. 1. The control module 34 is further configured to allocate a public key to a secret information.

According to an exemplary embodiment, the apparatus 32 comprises: the control module 34 configured to select a public key PK from a memory module 38, cause to allocate the public key PK to an indication and a signature information determined to be contained in a broadcast message which is to be transmitted, upon request, transmit the indication, and, upon receipt of a public key acceptance information, cause to transmit the public key PK.

According to another exemplary embodiment, the apparatus 32 may be a network entity such as a Mobile Switching Centre with Visitor Location Register (MSC/VLR), Serving GPRS Support Node (SGSN), Mobility Management Entity (MME), combinations thereof, or the like which may be connected with a Cell Broadcast Center (CBC). The control module 34 can be a component of a MSC/VLR and/or SGSN and/or a MME or of the CBC or of a combination of a CBC with a MSC/VLR and/or SGSN and/or a MME.

Moreover, selection of a public key PK may also include generating information related to changing the public key. This may include information to use a following public key of a list of public keys, a certain public key of a list of public keys, and/or the like. This option may be practical if more than one public key, e.g. two or more public keys, a list of public keys, or the like, are/is present at an authority of a receiving site (other apparatus) providing verification of broadcast messages. Preferably, at least one public key is indicated as valid to be used for verification purposes. The public keys can be provided with a Public Key Identifier (PKI). The apparatus 30 may provide an indication allocated to the public key.

According to an exemplary embodiment, the public key is allocated to signature information determined to be contained in a broadcast message which is to be broadcast. The signature information can be generated by a private key corresponding to the public key. Preferably, the signature information may be a digital signature, a certificate, especially, an implicit certificate, combinations thereof, or the like. If a broadcast message is to be broadcast, the broadcast message will be provided with the signature information. So, the receiving site (other apparatus 12) can verify the broadcast message. For this purpose, the public key is transmitted, e.g. by the apparatus 32, some time before the broadcast message is sent.

Another exemplary embodiment is that the control module 34 is configured to cause to transmit the indication only once. This prevents the apparatus 32 from transmitting the indication more than necessary resulting in a avoiding transmission in vain.

Yet another exemplary embodiment is that the control module 34 is configured to cause to continue using secret information determined to generate signature information contained in a broadcast message which is to be transmitted, which secret information is allocated to a previous public key for a maximum time period of the other apparatuses 12. This allows ensuring that broadcast messages can be verified by the other apparatuses 12 during an update process which may be determined by the largest possible timer period of the other apparatuses 12.

It is further an exemplary embodiment that the indication includes the public key and/or a reference allocated to the public key.

Another exemplary embodiment is that the control module 34 is configured to detect receipt of a request for a public key, and, in response thereto, cause to select the public key. The request is preferably a request of another apparatus 12 that is to verify broadcast messages by use of public keys. Generating may include generating of a new public key and/or information about to change or replace the public key by another one that may be already available in the other apparatus 12.

According to a further exemplary embodiment, the control module 34 is configured to cause to discard an invalid public key. This can be achieved by canceling the invalid public key from a storage area or the like. So, the number of public keys to be stored can be reduced. Especially, this embodiment allows removing invalid public keys when further use is not to be expected such as may be reasonable for change over purposes.

Another exemplary embodiment is that the control module 34 is configured to determine receipt of a message related to the timer expiring, and suppress to send the public key. So, a substantially continuous verification procedure in the other apparatus 12 can be achieved. At the same time, the new public key will be sent only after expiring of the present public key is to be expected.

According to another exemplary embodiment, the control module 34 is configured to suppress to send a new public key as long as the present public key is valid. So, resources can be saved.

Yet a further exemplary embodiment is that the control module 34 is configured to provide a broadcast message to be broadcast with a signature information, wherein the signature information is generated by the secret information allocated to the valid public key, and cause the transmitter 36 to broadcast the broadcast message. This enables the other apparatus 12 to verify the sender such as e.g. the network entity of the broadcast message. So, security of the information of the broadcast message can be enhanced.

Anther exemplary embodiment is that the control module 34 is configured to provide another broadcast message with a signature information which is generated by the secret information allocated to an invalid public key for a time period, determined as a maximum possible timer period for a timer of another apparatus 12. So, a change over period can be established allowing substantially all other apparatuses 12 having different timer periods to verify still broadcast messages when the new public key is still not yet accepted because the individual timer period is still lasting. The time period can be adapted to a maximum timer period of preferably any of the other apparatuses 12.

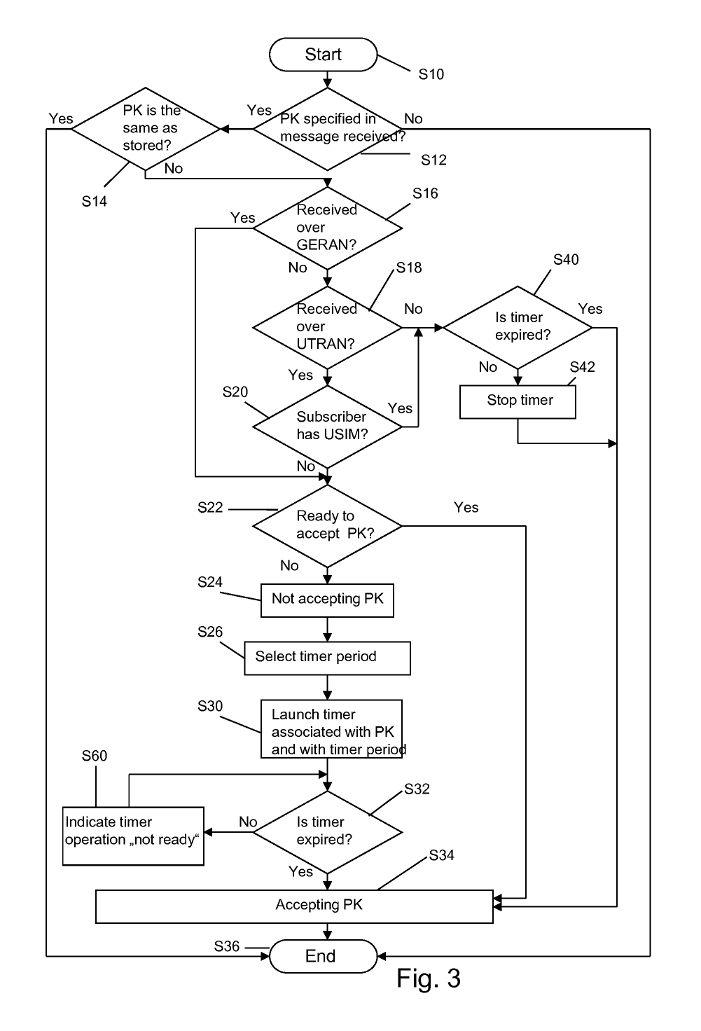

FIG. 3 depicts a flow chart, indicating an exemplary operation according to the invention related to e.g. a user equipment UE such as the user equipment 10 of FIG. 1. The process starts at step S10. At step S12, it is determined, whether a public key PK is received in a specified message by the receiver 16. The specified message can be included in a LAU, RAU, TAU signaling. If no, the process ends. If yes, it is further determined at step S14, whether the received public key PK is the same as at least one that is already stored in the user equipment 10. If yes, the process ends. If no, the process proceeds with step S16, where it is checked whether the message has been received over GERAN. If yes, the process proceeds with step S22. If no, it is further determined in step S18, whether the message has been received over UTRAN. If yes, it is determined, whether the subscriber of the user equipment 10 has a USIM. If no, it is proceeded with step S22.

In step S22, it is determined, whether the user equipment 10 is ready to accept the public key PK received in step S12. (The user equipment 10 is in state ‘ready to accept’ for a public key if, for this public key, a timer was running before, as described in the following steps S24, S26, S30, and has expired, or if the public key is identical to the one already stored.) If yes, the public key received is accepted at step 34 and the process ends at step 36. If no, the process is continued at step S24. In the following step S26, a timer period is selected, or generated respectively. Generally, the steps S24 and S26 can also be exchanged or provided at the same time.

The process proceeds with step S30 by launching the timer 20 with the timer period, whereby associating it with the public key PK received and the timer period such as loading the timer period in the timer 20. After the timer 20 has been started, it is further surveyed in step S32, whether the timer 20 is expired. If no, step S32 is repeated. If yes, the public key received is accepted at step S34. The process proceeds with step S36 by ending it.

During repetition according to step S32, step S60 may be provided in an exemplary embodiment. If the result in step S32 is no, the timer operation may be indicated at step S60. Indication may be directed to the network entity 30 or the like. The process proceeds with step S32.

If in step S18 the result is no, or in step S20 the result is yes, the process proceeds with step S40, where it is determined whether the timer 20 is expired. If yes, the process proceeds with step S34 by accepting the public key received. If no, in step S42, the timer 20 is stopped, preferably by including resetting the timer 20. The process proceeds with step S34 by accepting the public key received.

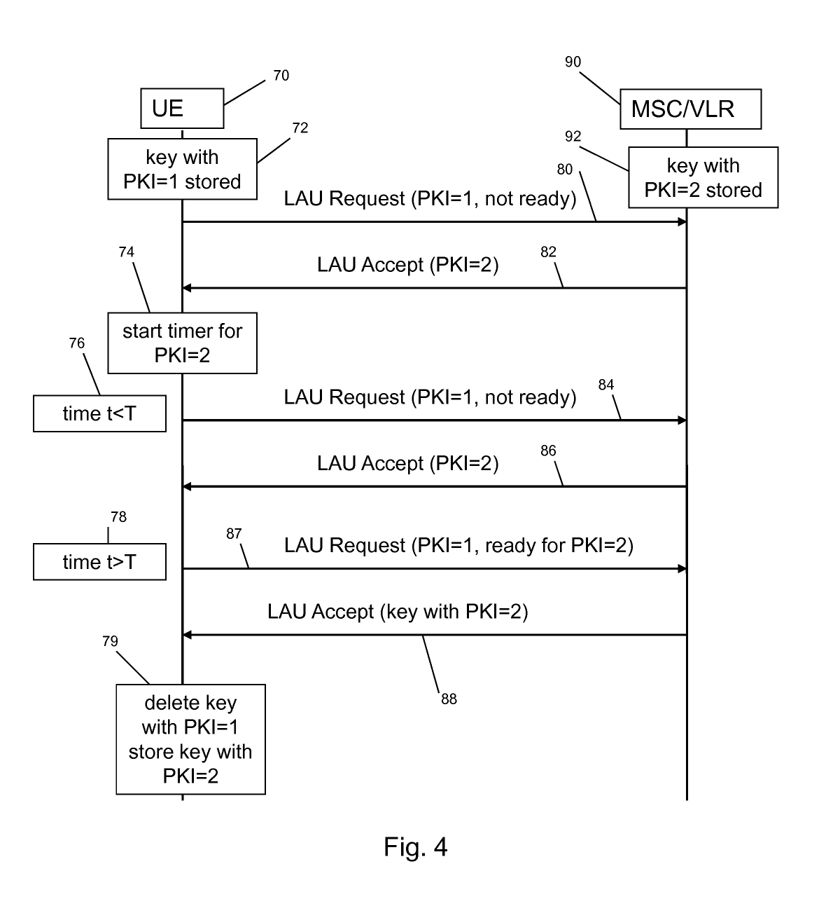

Another exemplary embodiment is detailed wherein referring to FIG. 4 depicting a signaling chart related to a public key update process for a user equipment. The vertical direction of this chart refers to the time, whereas the horizontal direction indicates the participating devices, namely, a user equipment UE 70, which may be the user equipment 10 according to FIG. 1, and a network entity such as a Mobile Switching Center/Visitor Location Register (MSC/VLR) 90.

As can be derived from FIG. 4, the starting conditions are that the user equipment UE 70 stores a PWS-related public key 72 having an identifier of 1 indicated in FIG. 4 as “key with PKI=1 stored”. Moreover, the MSC/VLR 90 stores a newer public key 92 having an identifier of 2 indicated in FIG. 4 as “key with PKI=2 stored”.

As can be further derived from FIG. 4, the user equipment 70 initiates transmitting of a LAU request 80. Such a LAU request may be transmitted periodically. The LAU request indicates that the user equipment 70 has stored the public key having the identifier of 1. The LAU request further indicates that the user equipment 70 is not ready to receive a new public key. So, the user equipment 70 is not ready for public key update.

The MSC/VLR 90 receives the LAU request 80 of the user equipment 70. The MSC/VLR 90 transmits, in response, a LAU accept 82. In the LAU accept, the MSC/VLR 90 indicates to the user equipment 70 that it has a public key having the identifier of 2.

The user equipment 70 receives the LAU accept 82 and detects that the MSC/VLR 90 has the public key having the identifier of 2. Consequently, the user equipment 70 starts or launches, respectively, the timer 20 associated with the public key having the identifier of 2 at 74. In an exemplary embodiment, a time of the timer 20 is set t=0. The timer 20 counts the time and when a time T of a predefined time period is reached, the user equipment 70 will be ready to accept the new public key having the identifier of 2 that is t=T. The value for T is set by the user equipment 70 randomly, wherein a certain limited range is considered.

During processing of the timer 20 at 76 that is when the timer 20 is started but has not yet expired (t<T), the user equipment 70 may transmit another LAU request 84. This LAU request 84 may indicate to the MSC/VLR 90 that it still has the public key having the identifier of 1 but it is not ready to receive a new public key.

The MSC/VLR 90 receives this other LAU request 84 of the user equipment 70 and responds with transmitting another LAU accept 86 wherein indicating that MSC/VLR 90 has the public key having the identifier of 2.

When the timer 20 has expired and the user equipment 70 transmits yet another LAU request 87 at 78 that is the timer 20 has expired (t>T), the LAU request 87 indicates to the MSC/VLR 90 that the user equipment 70 has the public key having the identifier of 1 but is now ready to receive a new public key.

The MSC/VLR 90 receives the LAU request 87 and responds with a LAU accept 88 including the public key having the identifier of 2. In turn, the user equipment 70 receives the LAU accept 88 and deletes the public key having the identifier of 1 and stores the public key having the identifier of 2 instead at 79. So, the public key of the user equipment 70 has been updated.

Another exemplary embodiment is detailed below.

As already indicated above, a Public Warning System PWS may use mobile phones as user equipments UE 10 (FIG. 1) to warn users of e.g. imminent disasters like earthquakes or tsunamis. Such a PWS may be similar to 3GPP™, Release 8 or later, i.e. GSM including GPRS, UMTS, and EPS or LTE, respectively. However, this PWS is not accompanied by any security measures, resulting in attackers being allowed injecting false warning messages, for instance in crowded places to create panic, or performing other unwanted or dangerous actions using the PWS.

Countermeasures against certain PWS security problems may pertain two parts. First, the warning message itself, which may be sent over a radio broadcast channel, may be secured by digitally signing it with a private key held in the network such as the apparatus 32 (FIG. 2), especially, the Cell Broadcast Entity (CBE). Second, the public key corresponding to the private key may be distributed to the user equipment UE 10 in a secure way so that the user equipment UE 10 can use the public key for verifying the digital signature of a warning message. The distribution of the public key shall occur well in advance of the sending of any warning message. The problem here is to prevent an attacker from distributing false public keys to user equipments UE 10. If the attacker did so, he would also be able to forge digital signatures of warning messages using the corresponding false private key selected by him and, in this way, send false warning messages that would be accepted by affected user equipments UE 10.

According to an approach for the second part, there is provided a NAS-based approach. In the NAS-based approach, public keys are sent from a core network node such as a Mobile-services Switching Centre (MSC), a Serving GPRS Support Node (SGSN), a Mobility Management Entity (MME) in a NAS message to the user equipment UE 10, wherein the public keys are protected by usual NAS security defined for GSM, UMTS, or EPS respectively. An aspect of the invention is focused on enhancing this approach.

The NAS-based approach to PWS security can have the problem that it relies on the NAS security defined for GSM, UMTS, and EPS, and that, while security for subscribers with a Universal Subscriber Identity Module USIM may be strong over UMTS Terrestrial Radio Access Network UTRAN and Long Term Evolution LTE, security for any subscriber may be weak over GSM EDGE Radio Access Network GERAN and security for 2G subscribers is even weak over UMTS Terrestrial Radio Access Network UTRAN.

Therefore, it is an object of the invention to close the afore-mentioned PWS security gap over GERAN and for 2G subscribers over UTRAN for the NAS-based approach in a simple and cost-effective manner, thus avoiding the standardization of complex changes to GSM in 3GPP.

The invention may also help with the approach using GBA based protection for 2G subscribers.

For the approach using GBA based protection, the situation is even worse for 2G subscribers than with the NAS-based approach because user equipment UE-initiated GBA is not possible for CS-only subscribers, and quite difficult, from a performance point of view, for low-bandwidth GPRS subscribers, as 2G Generic Bootstrapping Architecture (GBA) involves a Transport Layer Security (TLS) tunnel and a complex protocol handling. The low complexity GBA push is not available at all for 2G subscribers.

The invention can be applied for enhancing the security of public key distribution over GERAN for 2G, 3G, or 4G subscribers. The invention can also be applied to 2G subscribers with access over UTRAN.

The invention may also be directed to counter attack scenarios, in which an attacker uses a false base station first to distribute a false public key, for which he knows the corresponding private key, over Location Area Update (LAU)/Routing Area Update (RAU) Accept messages and then broadcast false warning messages in order to create a panic.

Such a panic is most effectively created in a crowd. It is assumed that such crowds gather for some time and then disperse, or that the members of a crowd are changing over time. It is further assumed that the attacker cannot determine the members of a crowd, and communicate with them, in advance. Consequently, the attacker has to perform both of the tasks, namely, distributing the false public key and broadcasting the false warning messages, in a relatively short period of time, e.g. some hours or the like.

According to an exemplary aspect of the invention, any public key update is to be delayed, especially, when provided over GERAN, so that the attacker can no longer perform both of the before-mentioned tasks while the crowd is gathering.

When, according to an exemplary embodiment, a user equipment UE 10 of a 2G, 3G, or 4G subscriber receives a Location Area Update LAU or Routing Area Update RAU Accept message over GERAN that indicates a required public key change, or contains a new public key, then the user equipment UE 10 shall not accept this public key, but start a timer 20 associated with this public key. Only when the timer 20 is up, the user equipment UE 10 shall accept this public key. Detailed rules for handling this timer 20 in the user equipment UE 10 and in the communication between user equipment UE 10 and network 30 can be found in the following section.

Timers, such as e.g. counters, nonces, or the like, are well-known elements in protocol design. This approach relates to using a timer for a specific security purpose and defining rules for handling this timer 20 in specific security events related to PWS as well as communication events like inter-RAT movements or Location Area Updates LAU or Routing Area Updates RAU.

When a UE of a 2G, 3G, or 4G subscriber receives a LAU or RAU Accept message over GERAN that indicates a required public key PK change, or contains a new public key PK, then the user equipment UE 10 does not accept this public key PK, but starts a timer 20 associated with this public key PK. Only when the timer 20 is up the user equipment UE will accept this public key PK. The UE will indicate in the next LAU or RAU Request message over GERAN that it is now ready to accept this particular public key and will store this key when receiving it in the response. When this key is not contained in the response the UE will delete any information about this particular public key. The value of the timer 20 can be randomly selected by the user equipment UE 10 from an interval between x hours and y hours where suitable values for x and y would have to be determined such as e.g. x=12 and y=24. It is preferred that the network entity 30 is not allowed to influence the setting of the timer 20.

When a LAU or RAU Accept message over GERAN is received while the timer 20 is running, and this message confirms (one of) the currently stored public key(s), then the user equipment UE 10 stops the timer 20. When a LAU or RAU Accept message over GERAN is received while the timer 20 is running, and this message indicates a change to a public key PK not stored in the user equipment UE and different from the one for which the timer 20 is running, then the user equipment UE 10 stops the timer 20 and starts a timer 20 for the newly received or indicated public key PK.

When the user equipment UE 10 moves to UTRAN or E-UTRAN and the subscriber has a USIM then the timer 20 is stopped.

In order to minimize the number of public keys PK sent by the network 30 in a LAU or RAU Accept message over GERAN, if a timer 20 is running for a particular public key the user equipment UE can indicate this fact in any LAU or RAU Request message over GERAN. This would keep the MSC or SGSN from sending this public key PK in the response to that request in vain. But it does not prevent the MSC or SGSN from sending any other public key PK or public key indicator.

The network can continue signing warning messages as broadcast messages with the old private key at least for a period as long as the maximum value of the timer 20. In this way, user equipments UE can verify genuine warning messages using the old public key PK while the timer 20 is running.

It is explained in the following how an attacker could perform an attack and why the methods known from prior art are inadequate to counter this attack.

As a basic attack, an attacker can perform in GERAN access networks first distributing a false public key, for which the attacker knows the corresponding private key, to victim user equipments UE and then send false warning messages, e.g. in order to create a panic in a crowded place. The difficult part is feeding sufficiently many user equipment UE the false public key; once this has been done the signing and broadcasting of false warning messages is straightforward. So, the distribution of false public keys is focused in this embodiment.

One tool for the attacker may be a false base station. Once the attacker has managed to make a user equipment UE camp on the false base station, the attacker can enforce unciphered communication by simply not sending a Cipher Mode command or setting the algorithm to A5/0 or GEA0. The attacker then has to simulate a communication with the GSM/GPRS core network. This is the easiest form of the attack as the attacker can then feed the false public key unciphered.

But even if the communication was ciphered, the attacker could still feed a false public key to the user equipment UE if the attacker managed to play a man in the middle (Mitm) between the user equipment UE and a base station BTS or the user equipment UE and SGSN. In this variant of the attack, the attacker may just forward the communication between the user equipment UE and network unchanged, with one exception: it modifies the ciphered public key sent from the Mobile Switching Center (MSC) or SGSN in such way that the attacker's own public key is delivered to the user equipment UE in a ciphered way. The attacker can do this, if the attacker can play Mitm, because 2G uses stream ciphers, the public key is known, the position of the ciphered public key in a LAU/RAU message is known, and the error detecting code is linear; hence the public key can be modified by a Mitm even when the message is ciphered by XOR-ing the delta between the genuine and the false public key to the ciphered public key and adjusting the error detecting code.

The protection by a basic variant seems to consist in mandating the network to switch ciphering on. But this does not help if an attacker with a false base station attack can enforce NULL encryption. Ciphering would help if an attacker rejected LAU/RAU messages without encryption.

A variant of this solution is that only ciphering LAU would be difficult as, in the CS domain, ciphering is done in the BTS, so the BTS would have to parse the signaling to identify LAU ACCEPT messages. The latter argument would also apply to other forms of partial ciphering, e.g. ciphering only of the public key. I.e. all forms of partial ciphering would require changes to the BTSs in GSM. This is considered infeasible due to the involved cost.

Finally, a variant addresses the security when ciphering is not applied. The considerations have indeed some merit as the NAS-based solution(s) add a security margin by the mere fact that (1) public keys are distributed over a separate channel from warning messages, (2) NAS messages provide a periodic check whether the public key is the correct one, (3) it may be difficult to set up powerful false base stations in crowded places without being noticed. Still, the added security margin may be insufficient to deter a well-prepared attacker with considerable resources, so, this variant of its own may not be good enough.

Further it can be derived an integrity key Kmac from the ciphering key Kc. But, for 2G subscribers, an attacker can use a false base station, enforcing a weak encryption algorithm, to obtain a valid GSM triplet (RAND, RES, Kc). This triplet can then be used in the next attempt to communicate with the UE using a Kmac derived from Kc. Furthermore, it is not clear from the description whether the integrity protection would, in the CS domain, be applied in the BTS or in the MSC. Burdening the BTS with this task would be an unwelcome change due to the cost, and adding integrity to the MSC would be a significant change in architecture.

A mechanism consists of sending periodic test warning messages so that the user equipment UE can check whether it has the right public key by verifying these test messages. But this approach would not help against the false base station attack. An attacker would be able to distribute false public keys and broadcast false test warning messages because the attacker would also know the corresponding private key. And, if the user equipment UE received test warning messages verifiable with the correct public key shortly before or after receiving the false public key, it would still accept or keep the false key as a user equipment UE may keep, according to the concept of NAS-based public key distribution, two public keys, a current one and one for future use. Once the distribution of false public keys was complete the attacker could start sending false serious warning messages.

Advantages:

The invention is suitable to prevent from attacks creating panic in crowds using false warning messages. The solution would also prevent attacks in other scenarios, e.g. against people in a large residential or office building who spend much of their time there every day, provided the attacker is unable to sustain a false base station attack over a period given by the timer T. This is so because, when the user equipment UE no longer camps on the false base station, switches to a genuine base station, and sends another LAU/RAU request to the genuine network while the timer is running, the LAU/RAU Accept message indicates the genuine public key, leading the user equipment UE to stop the timer. Sustaining the attack would be difficult as subscribers would be likely to notice a deviation from normal service.

It should also be taken into account in the evaluation that events triggering genuine warning messages are quite rare events, which reduces the probability for a subscriber to reject such a genuine warning message due to the timer running. This, of course, may depend on the mobility pattern: somebody crossing borders every day would have a high probability of missing a genuine warning message. But this could be perhaps alleviated by keeping an old public key stored for some time, even if it is from a different PLMN, or keep a timer running.

The solution can be realized by addition of timer handling logic in the user equipment UE and the MSC/VLR or SGSN, and, possibly, an enhancement to LAU/RAU requests for including the indication that a timer is running for a particular public key. This seems much simpler than adding integrity protection or partial ciphering to 2G, which, at least in the CS domain, would impact even base station systems.

Moreover, other systems can also benefit from the principles presented herein as long as they have identical or similar properties like the broadcast messaging as detailed herein. Embodiments of the present invention may be implemented in software, hardware, application logic or a combination of software, hardware and application logic. The software, application logic and/or hardware generally reside on control modules of terminal devices or network devices.

In an exemplary embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or a smart phone, a user equipment, or the like.

The present invention can advantageously be implemented in user equipments or smart phones, or personal computers connectable with such networks. That is, it can be implemented as/in chipsets to connected devices, and/or modems thereof. More generally, various systems which allow for a broadcast operation mode, especially, relying on cellular communication, may see performance improvement, especially in view of broadcast message consistency, with the invention being implemented thereto.

If desired, the different functions and embodiments discussed herein may be performed in a different order and/or concurrently with each other in various ways. Furthermore, if desired, one or more of the above-described functions and/or embodiments may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also observed herein that, while the above describes exemplary embodiments of the invention, these descriptions should not be regarded as limiting the scope. Rather, there are several variations and modifications which may be made without departing from the scope of the present invention as defined in the appended claims.

### LIST OF ACRONYMS

PWS Public Warning System

GSM Global System for Mobile Communications

GPRS General Packet Radio Service

UMTS Universal Mobile Telecommunications System

EPS Evolved Packet System

LTE Long Term Evolution

LAU Location Area Update

RAU Routing Area Update

GERAN GSM EDGE Radio Access Network

EDGE Enhanced Data Rates for GSM Evolution

USIM Universal Subscriber Identity Module

ETWS Earthquake and Tsunami Warning System

UE User equipments

UL Uplink

DL Downlink

CBE Cell Broadcast Entity

NAS Non-Access Stratum

MSC Mobile-services Switching Centre

SGSN Serving GPRS Support Node

MME Mobility Management Entity

UTRAN UMTS Terrestrial Radio Access Network

GBA Generic Bootstrapping Architecture

CS Circuit Switching

TLS Transport Layer Security

PKI Public-Key Infrastructure

CBC Cell Broadcast Center

CBE Cell Broadcast Entity

MSC Mobile Switching Center

VLR Visitor Location Register

PKI PWS Public Key Identifier

1. An apparatus, comprising:
a control module configured to
receive a specified message including an indication of a public key for verification of broadcast messages,
in response to having received the indication, select a timer period associated with the indication of the public key received, launch a timer for the selected timer period, and
upon expiry of the timer, cause to indicate acceptance of the public key.

2. The apparatus according to claim 1, wherein the control module is configured to
identify the indication of the public key received as matching a public key already stored, and,
responsive thereto, stop the timer.

3. The apparatus according to claim 1, wherein the control module is configured to
receive a specified message including another indication of a public key during operation of the timer,
select another timer period associated with the other indication received, and reset and launch the timer with the other timer period.

4. (canceled)

5. The apparatus according to claim 1, wherein the control module is configured to
cause to transmit a request for a public key.

6. (canceled)

7. (canceled)

8. An apparatus, comprising:
a control module configured to
select a public key from a memory module,
cause to allocate the public key to an indication determined to be contained in a message which is to be transmitted,
upon request, transmit the indication, and,
upon receipt of a public key acceptance information, cause to transmit the public key.

9. (canceled)

10. The apparatus according to claim 8, wherein the control module is configured to
cause to continue using secret information determined to generate signature information to be contained in a broadcast message which is to be transmitted, which secret information is allocated to a previous public key for a maximum time period of the other apparatuses.

11. The apparatus according to claim 8, wherein the indication includes the public key and/or a reference allocated to the public key.

12. A method, comprising:
receiving a specified message including an indication of a public key for verification of broadcast messages,
in response to having received the indication, selecting a timer period associated with the indication of the public key received, launching a timer for the selected timer period, and
upon expiry of the timer, causing to indicate acceptance of the public key.

13. The method according to claim 12, further comprising:
identifying the indication of the public key received as matching a public key already stored, and,
responsive thereto, stopping the timer.

14. The method according to claim 12, further comprising:
receiving a specified message including another indication of a public key during operation of the timer,
selecting another timer period associated with the other indication received, and resetting and launching the timer with the other timer period.

15. (canceled)

16. (canceled)

17. The method according to claim 12, comprising:
causing to transmit a message related to the timer expiry.

18. The method according to claim 12, wherein the indication includes the public key and/or a reference allocated to the public key.

19. A method, comprising:
selecting a public key from a memory module,
causing to allocate the public key to an indication determined to be contained in a message which is to be transmitted,
upon request, transmitting the indication, and,
upon receipt of a public key acceptance information, causing to transmit the public key.

20. (canceled)

21. The method according to claim 19, comprising:
causing to continue using secret information determined to generate signature information to be contained in a broadcast message which is to be transmitted, which secret information is allocated to a previous public key for a maximum time period of the other apparatuses.

22. The method according to claim 19, wherein the indication includes the public key and/or a reference allocated to the public key.

23.-25. (canceled)
